(19) United States
(12) Patent Application Publication
(10) Pub. No.: US 2008/0189161 A1
(43) Pub. Date: Aug. 7, 2008

(54) RFID INFORMATION CONTROL

(76) Inventors: Michael A. Daily, Claremont, NC (US); Ronald D. Foster, South Bend, IN (US)

Correspondence Address: SNELL & WILMER LLP (OC), 600 ANTON BOULEVARD, SUITE 1400, COSTA MESA, CA, 92626, US

(21) Appl. No.: 12/026,168

(22) Filed: Feb. 5, 2008

Related U.S. Application Data
(60) Provisional application No. 60/899,553, filed on Feb. 5, 2007.

(51) Int. Cl. G06Q 10/00; G06F 17/30; G06Q 99/00

(52) U.S. Cl. 705/8; 705/1; 726/4

(57) ABSTRACT

The invention relates to a system and method for storing control information associated with RFID tags that allows entities that do not share common tracking systems to access relevant information to determine the status and location of tagged items. The tracking system may include a drop box having a housing for receiving a package with an RFID tag, a RFID reader positioned within the housing for scanning the RFID tag to obtain control information and transmitting package received information, and a RFID processing module for receiving the package received information from the RFID reader and scheduling a pick up of the package using the package received information.

### CLAIM OF PRIORITY UNDER 35 U.S.C. §119

The present Application for patent claims priority to Provisional Application No. 60/899,553 entitled “RADIO FREQUENCY IDENTIFICATION INFORMATION CONTROL,” filed Feb. 5, 2007, and assigned to the assignee hereof and hereby expressly incorporated by reference herein.

### BACKGROUND

1. Field

The present invention relates to a system and method for creating, storing and utilizing radio frequency identification (RFID) control information. More particularly, the invention relates to storing control information in a common database and transferring the control information to an RFID tag to allow entities that do not share common tracking systems to access the control information to determine the status and location of a tagged item.

2. Background

Many companies have set up tracking systems that are used to track items. When an item travels from a start location to a destination location, multiple supply chain companies may be involved in transferring the item. Companies in the supply chain often utilize different and incompatible tracking systems. For example, the manufacturer of an item may use a first tracking system to locate the item within its factory or warehouse. The shipper of the item may use a second tracking system to ship the item from a first location to a second location. The shipper may have a RFID reader at the start location and at the destination location. When the item with the RFID tag arrives at the start location, the RFID tag is scanned by the RFID reader. When the item with the RFID tag arrives at the destination location, the RFID tag is scanned by the RFID reader. However, during shipment from the start location to the destination location, multiple shipping companies with different tracking systems may be involved in shipping the item. Furthermore, the retail or wholesale company purchasing the item may use a third tracking system to locating the item within its network of stores. In many instances, the different tracking systems cannot communication with one another and the item can only be tracking if it is under the control of the company responsible for the item.

Various drawbacks of these types of tracking systems include the inability of a third party individual or company to add or modify information contained on the RFID tag, prohibiting entities that do not share common tracking systems to access relevant information to determine the status and location of tagged items, and the inability of a third party individual or company to track an item that it is going to receive from another source.

Therefore, a need exists in the art for techniques that allows an entity to “reach in” to other operations and input its own control or tracking information on the tagged item.

### SUMMARY

The present invention includes a tracking system for storing control information associated with RFID tags that allows entities that do not share common tracking systems to access relevant information to determine the status and location of tagged items. The tracking system may include a drop box having a housing for receiving a package with an RFID tag, a RFID reader positioned within the housing for scanning the RFID tag to obtain control information and transmitting package received information, and a RFID processing module for receiving the package received information from the RFID reader and scheduling a pick up of the package using the package received information.

The present invention includes a computer-based method of accessing a third party database to obtain control information to generate an RFID tag using a remote device. The method may include receiving shipping information for an item on a remote device, accessing a database to obtain control information corresponding to the item, transmitting the control information to the remote device, and using the remote device to generate an RFID tag for the item, the RFID tag including the control information.

The present invention includes a computer-based method of accessing a third party database to obtain control information to generate an RFID tag using a remote device. The method may include receiving a password and a shipping address for an item on a remote device, accessing a third party database using the password, receiving control information from the third party database, the control information corresponding to the item, and generating an RFID tag for the item using the remote device, the RFID tag including the control information.

### BRIEF DESCRIPTION OF THE DRAWINGS

The features, objects, and advantages of the present invention will become more apparent from the detailed description set forth below when taken in conjunction with the drawings, wherein:

FIG. 1 is a block diagram of a tracking system for producing and allowing the transfer of control information from multiple devices to an RFID tag according to an embodiment of the present invention;

FIG. 2 is a flow chart of a method of accessing a third party database to obtain control information to generate an RFID tag using a remote device according to an embodiment of the present invention; and

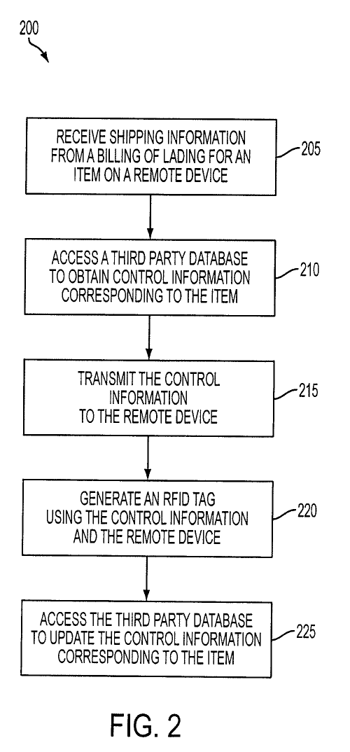

FIG. 3 is a flow chart of a method of determining whether a drop box contains a package for pickup according to an embodiment of the present invention.

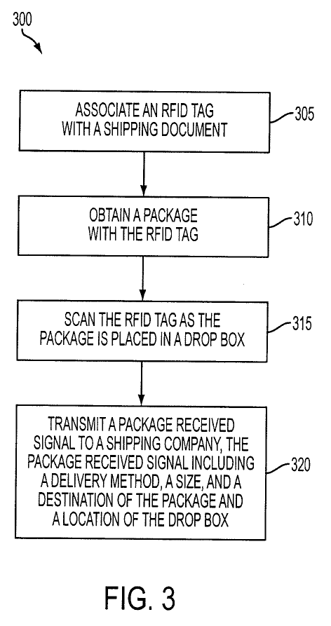

### DETAILED DESCRIPTION

Apparatus, systems and methods that implement the embodiments of the various features of the present invention will now be described with reference to the drawings. The drawings and the associated descriptions are provided to illustrate some embodiments of the present invention and not to limit the scope of the present invention. Throughout the drawings, reference numbers are re-used to indicate correspondence between referenced elements. In addition, the first digit of each reference number indicates the figure in which the element first appears.

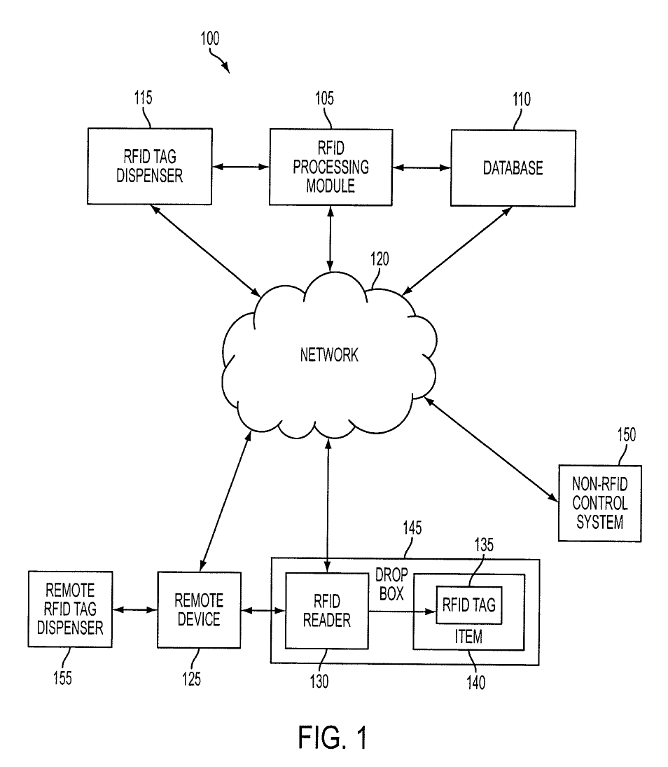

FIG. 1 is a block diagram of a tracking system 100 for producing and allowing the transfer of control information from multiple devices to an RFID tag according to an embodiment of the invention. The control information may include item name or number, item sales price, originating location, destination location, manufacturer name and address, vendor name and address, supplier name and address, buyer name and address, bill of lading information, invoice information, and shipping route information. The tracking system 100 also allows an entity to “reach in” to other operations and input its own control or tracking information on the tagged item.

The tracking system 100 may include a RFID processing module 105, a database 110, a RFID tag dispenser 115, a network 120, a remote device 125, a RFID reader 130, a RFID tag 135, an item 140, a non-RFID control system 150, and a remote RFID tag dispenser 155. Some advantages of the tracking system 100 include allowing global access to the database and to the control information, allowing control information to be transferred from multiple devices to RFID tags, and compatibility with other control systems and non-RFID control systems. In particular, one advantage of the present invention results from incorporating the RFID tag dispenser 115 with the RFID processing module 105 (or the RFID tag dispenser 155 with the remote device 125) that stores the dispensed RFID tag control information in the database 110 so it is globally available to any standard database command for use in any RFID-based control system in an integrated system. Throughout the disclosure, the RFID processing module 105 and the remote device 125 and the RFID tag dispenser 115 and the remote RFID tag dispenser 155 can be used interchangeably.

The RFID processing module 105 communicates with the RFID tag dispenser 115. The RFID tag dispenser 115 dispenses the RFID tag 135 with encoded control information. The RFID processing module 105 (or the RFID tag dispenser 115) can be an ADASA PAD3500, PAXAR Monarch or Printronix RFID printer. The RFID processing module 105 monitors and transmits the control information to the database 110, which allows the identifying control information to be accessed and used by other control devices, systems and non-RFID control systems regardless of the information format of the other devices or systems. The advantage of such information control means is apparent to one skilled in the art because individual control information methods require additional resources to make the information compatible and limits the methods and associated ancillary information controls.

The remote device 125 communicates with the remote RFID tag dispenser 155. The remote device 125 may be a Personal Digital Assistant (PDA), desktop or laptop personal computer, PDA-based cellular phone or related computer processing device. The remote device 125 can access the control information stored on the database 110, retrieve the control information corresponding to the item of interest, and transmit the control information to the remote RFID tag dispenser 155 to create or generate the RFID tag 135. The remote device 125 can produce and transfer the control information to the RFID tag 135 via various means of standard communication protocols such as, but not limited to, Bluetooth, infrared, serial and network based protocols. The control information is received by the remote device 125, which may include an RFID encoder, an RFID printer, and/or an RFID reader. The remote device 125 can process, dispense, and deliver the control information to the RFID tag 135.

The RFID tag 135 may be a VHF or UHF passive or active tag such as the Alien Squiggle or Avery Dennison AD-220. The control information encoded onto the RFID tag 135 is stored in the database 110. The database 110 may be a Microsoft SQL Server, ORACLE Database, SYBASE Database or IBM Server that runs computer software such as, but not limited to, Visual Basic, C++, Visual Basic.NET that takes the RFID tag control information and relates it to an associated object such as, but not limited to, an asset tracked object. The RFID tag control information is available on the database 110 for further RFID read information consumption and processing to solve the final control requirement such as, but not limited to, unattended drop boxes, locking systems, machine controls, material management systems, material movement, robotic controls, Point of Sale (POS) or other control methods common on the market. Information handling between the contiguous methods is bidirectional for informational feedback and error correction.

The tracking system 100 may be used to illustrate the apparatus and methods described herein for producing and allowing the transfer of control information from multiple devices to the RFID tag 135. The tracking system 100 and the components of the tracking system 100 may be implemented using hardware, software, firmware, middleware, microcode, or any combination thereof. One or more components can be rearranged and/or combined, and other systems can be used in place of the tracking system 100 while still maintaining the spirit and scope of the present invention. Additional components may be added to the tracking system 100 or may be removed from the tracking system 100 while still maintaining the spirit and scope of the present invention. The components of the tracking system 100 may be connected to each other using wireless and/or wired connections.

The tracking system 100 and method allows for the initiation of the tracking of the relevant item at the time a packing list or bill of lading information (identifying information) is created. The identifying information is entered on the remote device 125 and transferred to the database 110. In one embodiment, the remote RFID tag dispenser 155 is integrated with the remote device 125. The identifying information and corresponding RFID tag information may be communicated to other entities via wireless internet communication, for tracking of the tagged item 140. The RFID tag 135 and associated identifying information is not dependant on a single company's database and protocols. Thus, the RFID tag 135 and associated identifying information may be integrated into different tracking systems as the tagged item 140 travels in commerce.

A vendor utilizing the remote device 125 may enter identifying or shipping information contained on the bill of lading for a particular item 140 (block 205). If available, bar codes on the bill of lading and the tagged item 140 are read and recorded. The remote device 125 communicates with the purchaser's RFID processing module 105 (e.g., an ADASA PAD3500) to access the database 110 of the purchaser and obtain control information corresponding to the particular item 140 (block 210). For example, the vendor or supplier using the remote device 125 can directly access the purchaser's tracking system 100 to input control or identifying information in the database 110 and transmit the updated control or identifying information back to the remote device 125 to enable the remote device 125 to create an RFID tag 135 using the purchaser's system 100. Hence, the identifying information is transmitted to the remote device 125, which in turn dispenses the RFID tag 135 for the item 140 to be tracked (blocks 215 and 220). The RFID tag 135 is affixed to the item 140. The information entry can be in constant update mode with the remote device 125 in wireless communication via internet or network 120 to the RFID processing module 105 and/or the database 110 or the information may be inputted offline and downloaded in a batch. As the tagged item 140 is monitored via RFID tag reader 130, the database 110 may be accessed to ascertain relevant information. As the status or location of the tagged item 140 changes, the database 110 may be updated (block 225).

The RFID tag 135 is incorporated into a shipped item 140 or corresponding documentation. Shipping information is entered into the database 110 that corresponds to the RFID tag 135. The database information is accessed as the status or location of the tagged item 140 changes. The RFID tag reader 130 communicates with the database 110 and updates the database 110 as status of the tagged item 140 changes.

Express shipping companies utilize drop boxes 145 where shippers may deposit packages. The shipping companies expend resources to periodically check the drop boxes 145 to determine if any packages or items 140 have been deposited. Shipping company personnel checking empty drop boxes is inefficient resulting in wasted time and fuel. A drop box 145 is defined as a secure, locked container that allows packages to be placed therein and does not have a human being attending or monitoring the drop box 145. The RFID reader 130 may be placed inside the drop box 145 to prevent tampering of the RFID reader 130.

A manufacturer may manufacture an item, place the item in a package, and then place an RFID tag 135 created using the above method with the package. The RFID tag 135 may be incorporated into a shipping document or otherwise associated with the package (block 305). The manufacturer or the shipping company may have a drop box 145 that obtains the package with the RFID tag 135 (block 310). The drop box 145 may have an RFID reader 130 that reads or scans the RFID tag 135 periodically or as the package is dropped into the drop box 145 (block 315). The drop box 145 is monitored continuously or periodically via the RFID reader 130. The RFID reader 130 may be remotely monitored by wireless or wired communication similar to conventional telephone communication or internet type communication. For example, the RFID reader 130 may transmit a package received signal to the shipping company to pick up the package from the drop box 145 (block 320). The package received signal may include information about the delivery method (e.g., 2 day air delivery), size (e.g., weight or dimensions), and destination (e.g., delivery address) of the package and the location (e.g., address) of the drop box 145 (block 320). Upon detection of the package received signal, the shipping company may direct personnel to access the drop box 145 to make the necessary pick up. The actual shipping information corresponding to the RFID tag 135 can be input into the database 110 by the shipper or after the package has been removed from the drop box 145. One advantage is that the shipping company may not have to visit the drop box 145 if no packages are present or immediately pick up the package because the delivery method is 5 day ground, for example.

The RFID processing module 105 may store computer instructions on a machine readable medium for controlling the operations and functions of the various components of the tracking system 100. The RFID processing module 105 may include one or more memory modules for storing instructions to control the operations and functions of the various components of the tracking system 100. The term “machine readable medium” includes, but is not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The RFID processing module 105 may be an Advanced RISC Machine (ARM), a controller, a digital signal processor (DSP), a microprocessor, or any other device capable of processing instructions.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A tracking system, comprising:
a drop box having a housing for receiving a package with an RFID tag;
a RFID reader positioned within the housing for scanning the RFID tag to obtain control information and transmitting package received information; and
a RFID processing module for receiving the package received information from the RFID reader and scheduling a pick up of the package using the package received information.

2. The tracking system of claim 1, wherein the drop box is a secure, locked container that allows packages to be placed therein and does not have a human attendant.

3. The tracking system of claim 1, further comprising a remote device for receiving a location of the drop box and a pickup date for the package from the RFID processing module.

4. The tracking system of claim 1, wherein the control information is selected from a group consisting of an item name or number, item sales price, originating location, destination location, manufacturer name and address, vendor name and address, supplier name and address, buyer name and address, bill of lading information, invoice information, shipping route information, and combinations thereof.

5. The tracking system of claim 1, wherein the package received signal includes delivery method information, package size information, package destination information, and drop box location information.

6. A computer-based method of accessing a third party database to obtain control information to generate an RFID tag using a remote device, comprising:
receiving shipping information for an item on a remote device;
accessing a third party database to obtain control information corresponding to the item;
transmitting the control information to the remote device; and
using the remote device to generate an RFID tag for the item, the RFID tag including the control information.

7. The method of claim 6, wherein the shipping information includes an address where the item is to be shipped.

8. The method of claim 6, wherein the third party database is controlled by a purchaser of the item and the remote device is controlled by a shipper of the item.

9. The method of claim 6, wherein the control information is selected from a group consisting of an item name or number, item sales price, originating location, destination location, manufacturer name and address, vendor name and address, supplier name and address, buyer name and address, bill of lading information, invoice information, shipping route information, and combinations thereof.

10. The method of claim 6, further comprising periodically scanning the RFID tag to determine the location of the item.

11. A computer-based method of accessing a third party database to obtain control information to generate an RFID tag using a remote device, comprising:
receiving a password and a shipping address for an item on a remote device;
accessing a third party database using the password;
receiving control information from the third party database, the control information corresponding to the item; and
generating an RFID tag for the item using the remote device, the RFID tag including the control information.

12. The method of claim 11, wherein the shipping information includes an address where the item is to be shipped.

13. The method of claim 11, wherein the third party database is controlled by a purchaser of the item and the remote device is controlled by a shipper of the item.

14. The method of claim 11, wherein the control information is selected from a group consisting of an item name or number, item sales price, originating location, destination location, manufacturer name and address, vendor name and address, supplier name and address, buyer name and address, bill of lading information, invoice information, shipping route information, and combinations thereof.

15. The method of claim 11, further comprising periodically scanning the RFID tag to determine the location of the item.
